(19) United States
(12) Patent Application Publication
(10) Pub. No.: US 2007/0030767 A1
(43) Pub. Date: Feb. 8, 2007

(54) Method, system, playback device and recorder for duplicating multi layer record carriers

(76) Inventor: Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/574,362

(22) PCT Filed: Oct. 1, 2004
(86) PCT No.: PCT/IB04/51949

§ 371 Date: Mar. 30, 2006

(30) Foreign Application Priority Data
Oct. 6, 2003 (EP) 03103693.2

(51) Int. Cl. G11B 7/085

(52) U.S. Cl. 369/30.11

(57) ABSTRACT

When a multi layer record carrier comprimising video information is to be duplicated on another multi layer record carrier the data spread over two recording layers on the source record carrier must also be spread over the two layers of the target record carrier. Once an appropriate layer transition for the target record carrier has been established the size of the first layer is adjusted by moving the first logical address, thus limiting logical address space on the first layer of the target record carrier to exactly fit the video information obtained from the first layer of the source record carrier. Once the logical address space has been adjusted the layer transition will happen automatically at the correct point in the video information during the recording.

This invention relates to a recording device for recording information provided to an input on a multi layer record carrier with a first layer, a second layer and a layer transition point, the recording device comprising writing means for writing information on the first layer of the record carrier and a processing means coupled to the input and to the writing means, and to a method for duplicating a source multi layer record carrier on a target record carrier.

Such a method is known from the present DVD copy programs available for personal computers.

Here a DVD reader retrieves the video information from the source multi layer record carrier, processes the video information and provides the processed video information to a DVD recorder for recording on a record carrier.

Because the DVD-ROM record carriers are available in a dual layer format the duplication of this type of record carrier is problematic on current recordable DVD record carriers because the current recordable DVD record carriers are single layer and provide only about half the recording capacity of the dual layer DVD ROM record carrier.

In order to fit video data from a dual layer DVD-ROM record carrier on a single layer DVD recordable record carrier the video information must be compressed which results in a loss of picture quality.

To this end a dual layer recordable DVD record carrier has been developed. This allows the duplication of the dual layer DVD-ROM record carrier while preventing the loss of picture quality due to compression because the dual layer DVD recordable provides enough storage capacity to hold the video information without further compression.

When receiving the video information the recording device is however faced with a problem.

Now that the DVD recordable comprises two recording layers compression is no longer required but a layer transition point must be established within the specifications of the DVD standard as applicable to DVD record carriers comprising video information in order to properly record the video information on the two layers of the target record carrier.

The recorder receives the video information and can process the video information to establish an appropriate point for the layer transition where the requirements of the DVD video standard are satisfied, i.e. the transition happens non-seamless and happens at a cell boundary. The recorder can scan the video information for a position where these conditions occur, and can consider whether that position is a suitable position, given the remaining capacity on the first layer of the record carrier, the remaining capacity required by the video information and the remaining capacity on the second layer.

A dual layer DVD-R recordable record carrier has a fixed layer transition point at the end of the physical address range of the first layer of the record carrier. This is the result of the pre-embossed lead-in area. Consequently the logical address of the layer transition point on the target record carrier will not coincide with the layer transition point of the source record carrier.

The disadvantage of this it that it will result in disturbances during the playback of the duplicated video information on the target record carrier.

It is an objective of the method of the present invention to overcome this disadvantage and provide an method for duplicating the source record carrier while maintaining the layer transition point at the same position in the video information as on then source record carrier.

In order to achieve this objective the method comprising the steps of

retrieving video information from a first layer on the source multi layer record carrier

retrieving video information from a second layer on the source multi layer record carrier

transferring the video information retrieved from the first layer and the second layer to a recording device

determining a suitable layer transition point in the video information

dividing the video information into a first video section and a second video section

adjusting a physical location of a first logical address on a first layer of the target multi layer record carrier so that when starting a recording of the first video section from the adjusted first logical address the determined layer transition point coincides with a logical address of a layer transition point of the target record carrier

recording the video information transferred to the recording device on the target multi layer record carrier starting at the adjusted first logical address on the first layer of the target multi layer record carrier.

By shifting the starting point of the first section of the video information on the first layer of the record carrier the end of the first section of the video information can be moved to coincide with the fixed layer transition point on the target record carrier. By adjusting the physical location of the first logical address the starting point of the recording on the target record carrier can be moved. The move of the start of the logical address space in the physical address space allows the recording of the video information to be shifted towards the fixed layer transition point. When the end of the recording of the video information coincides with the layer transition point the recorder will automatically perform a layer transition, triggered by the reaching of the end of the physical address space on the first layer of the target record carrier. The recorder will continue recording on the second layer and the remaining video information, the second video section, will be recorded on the second layer.

Because the physical address of the first logical address on the first layer is changed the area thus skipped can be left blank since any playback device will automatically skip this area in order to start the playback at the indicated first logical address.

Only considerations related to the readability of the dual layer record carrier can require the recording of dummy information in the skipped area between the start of the physical address space and the first logical address at the start of the logical address space.

In other words: to obtain a layer transition the recorder reduces the useable logical address space of the first layer based on the determined layer transition point such that when recording the video information an automatic layer jump is forced when the recording of the video information runs out of available space on the first layer of the target multi layer record carrier.

An embodiment of the method for duplicating a source multi layer record carrier is characterized in that characterized in that the step of determining a suitable layer transition point comprises the step of:

processing the transferred video information to determine a layer transition point complying with requirements for a layer transition.

Processing the video information received by the recorder allows the recorder to determine a point in the video information where a layer transition would comply with the applicable requirements for a layer transition such as being performed at a cell boundary, being non-seamless and being performed at a location where the short interruption of the playback is less obvious to the viewer.

A further embodiment of the method for duplicating a source multi layer record carrier is characterized in that the step of determining a suitable layer transition point comprises the steps of

retrieving a layer transition point from the source multi layer record carrier

transferring the layer transition point to a recorder

Instead of processing the video information to find a suitable location for the layer transition point, the original layer transition point as exists on the source record carrier can be used a s a starting point to determine a suitable layer transition point for the target record carrier. During authoring of the source record carrier all requirements that apply to a layer transition point have been considered already and a suitable layer transition point has been determined. The recorder can use this information, as provided to the recorder by a playback device arranged for providing, in addition to the video information the layer transition point. The recorder now only needs to establish the logical address of the start of the logical address space such that the received layer transition point in the video information coincides with the fixed layer transition point of the target record carrier.

A further embodiment of the method for duplicating a source multi layer record carrier is characterized in the step of adjusting a first logical address on a first layer of the target multi layer record carrier so that the determined layer transition point coincides with a logical address of a layer transition point of the target record carrier comprises the steps of:

calculating a logical address offset of the layer transition point from a start of the video information

subtracting the logical address offset from a maximum logical address of the first layer of the target record carrier to obtain an adjusted first logical address

storing the adjusted first logical address in an index file on the target record carrier

The first logical address of the first layer can be adjusted to a physical address by storing the adjusted physical address of the first logical address in an index file on the target record carrier. Any recording after the storing of the adjusted physical address in the index file will use the thus newly define logical address space because the recorder is arranged to use the logical addressing for recording. Thus the recording will start at the correct offset and will complete the recording of the first section of the video information exactly when reaching the end of the logical address space, and the end of the physical address space on the first layer.

The invention will now be described based on figures.

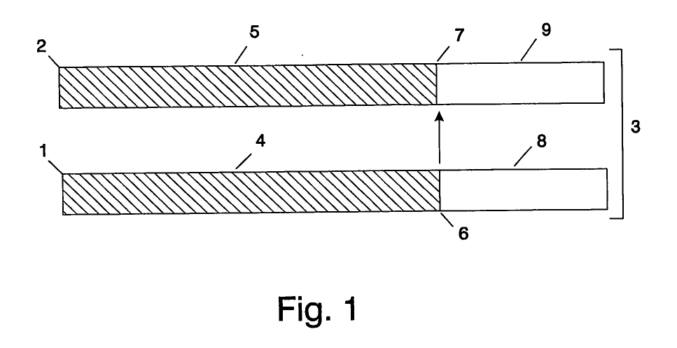

FIG. 1 shows video information recorded on a dual layer OTP record carrier.

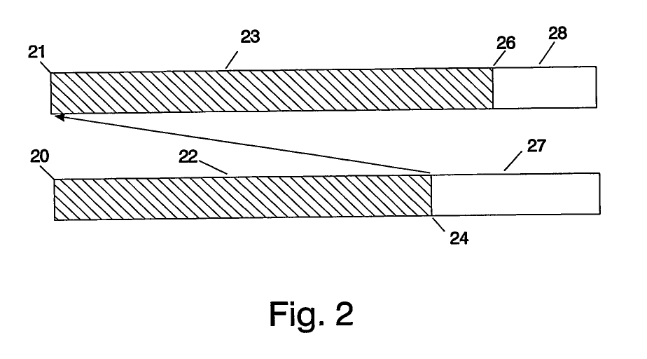

FIG. 2 shows video information recorded on a dual layer PTP record carrier.

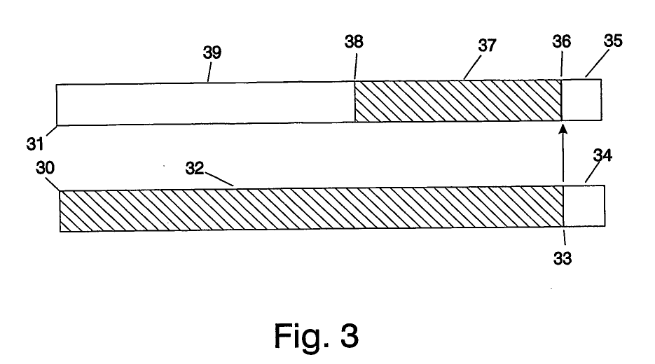

FIG. 3 shows video information duplicated on a dual layer OTP record carrier.

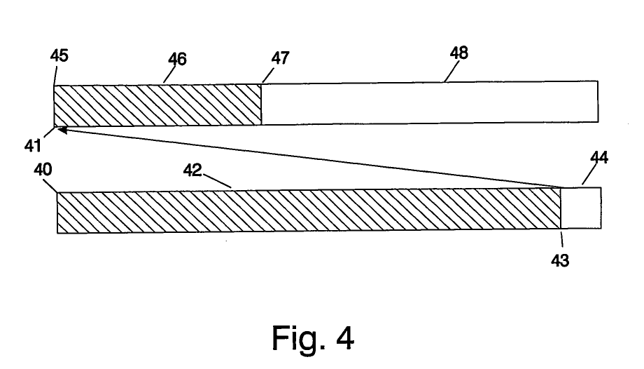

FIG. 4 shows video information duplicated on a dual layer PTP record carrier.

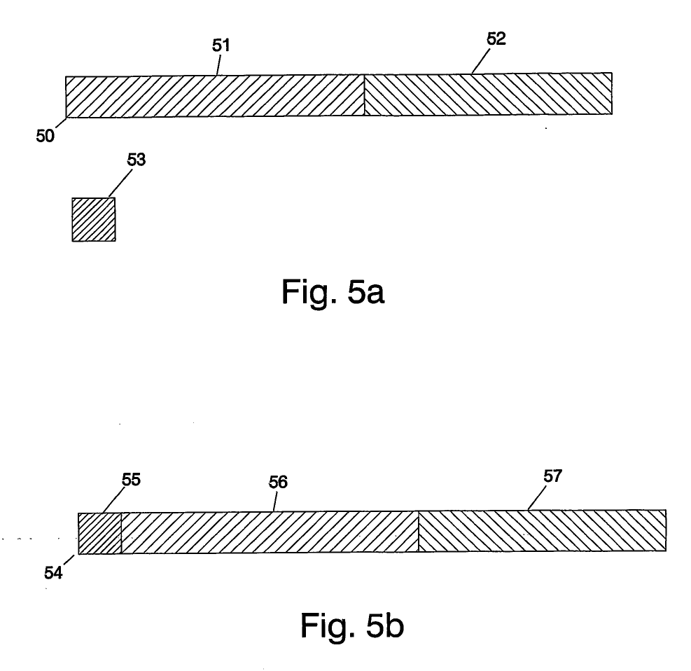

FIG. 5a shows a file structure for transferring the video information from a playback device to a recorder.

FIG. 5b shows a further file structure for transferring the video information from a playback device to a recorder.

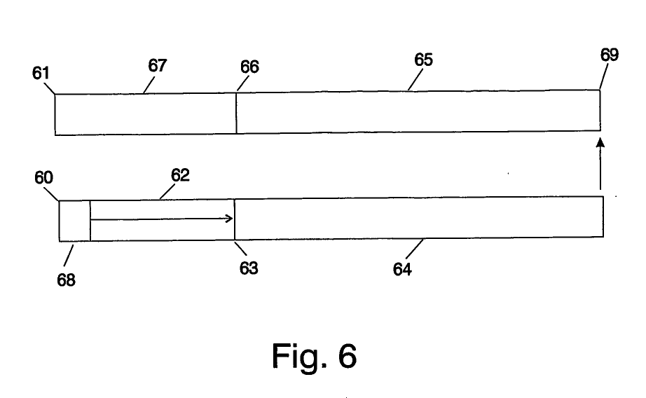

FIG. 6 shows a dual layer OTP record carrier prepared for duplicating another dual layer OTP record carrier.

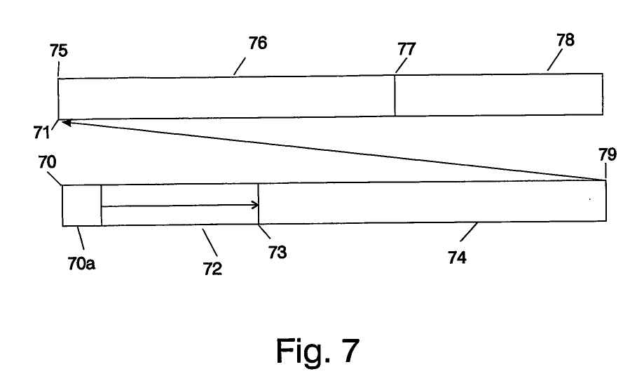

FIG. 7 shows a dual layer PTP record carrier prepared for duplicating another dual layer PTP record carrier.

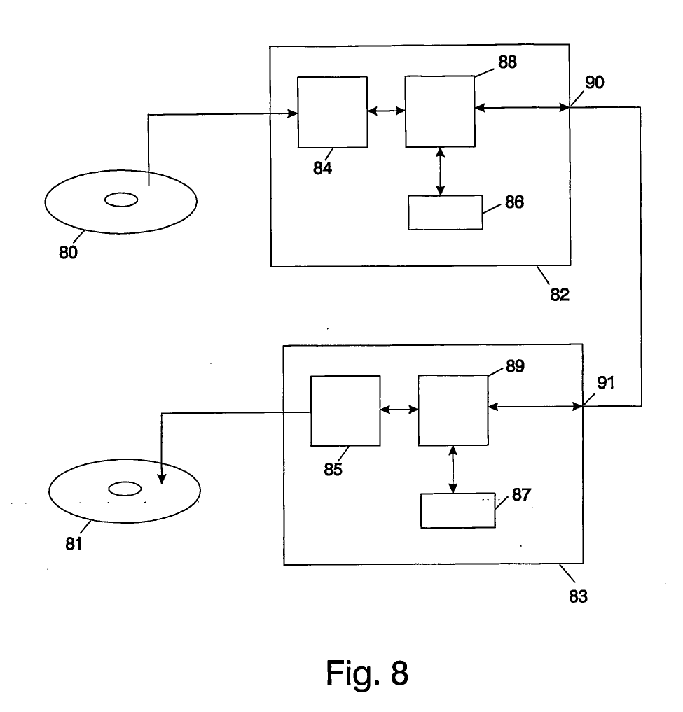

FIG. 8 shows a system for duplicating dual layer record carriers, comprising a playback device and a recorder.

FIG. 1 shows video information recorded on a dual layer OTP record carrier.

A record carrier 3 comprises a first layer 1 and a second layer 2 on which information is recorded. The information is video information, for instance an MPEG2 video stream. Because the video information doesn't fit on a single layer the first layer 1 comprises a first section 4 comprising video information and the second layer 2 also comprises a section with video information, the second section 5. Even if the video information would fit in it's entirety on the first layer 1 the publisher of the record carrier can still decide to split the video information in a first section on the first layer and a second section on a second layer for other reasons. Because the record carrier shown is of the OTP type the size of the first section 4 determines the maximum size of the second section 5. This is due to the fact that the first layer 1 is read from the start of the first layer outward up to the layer transition point 6 where the reading changes to the second layer 2 and continues inward through section 5. The second section 5 on the second layer 2 can thus never be larger than the first section 4 on the first layer 1.

The physical addressing of the layers spans the maximum size of the first layer and the maximum size of the second layer. In contrast to this the logical addressing on the OTP type record carrier runs from the start of the first section 4 on the first layer 1 outward to the layer transition point 6. The logical addressing continues at the start 7 of the second section and ends at the end of the second section 5.

Consequently a third section 8 on the first layer 1 and a fourth section 9 on the second layer are comprised in the physical addressing of the record carrier but not in the logical addressing. During mastering the layer transition point 6 is determined by processing the video data and searching for an appropriate scene, for instance with a low bit rate, occurring at a cell boundary where a non-seamless layer transition can be implemented. An additional objective is often to balance the amount of video information on both layers 1,2 and thus obtaining a first section 4 and a second section 5 that are approximately equal in size. This reduces the amount of padding required to fill the remaining area of the second section 5 not filled by the video information. The source record carrier shown can be a recordable type or a ROM type record carrier.

FIG. 2 shows video information recorded on a dual layer PTP record carrier.

A PTP type record carrier comprises a first layer 20 and a second layer 21 on which information is recorded. The information is video information, for instance an MPEG2 video stream. Because the video information doesn't fit on a single layer the first layer 20 comprises a first section 22 comprising video information and the second layer 21 also comprises a section with video information, the second section 23. Of course the publisher of the record carrier can decide to split the information over the two layers 20,21 for other reasons as well. Because the record carrier shown is of the PTP type the size of the first section 22 has no influence on the size of the second section 23. This is due to the fact that the first layer 20 is read from the start of the first layer outward up to the layer transition point 24 where the reading changes to the start 25 of the second layer 21 and again continues outward through the second section 23 up to the end 26 of the second section 23.

The physical addressing of the layers spans the maximum size of the first layer 20 and the maximum size of the second layer 21. In contrast to this the logical addressing on the PTP type record carrier runs from the start of the first section 22 on the first layer 20 outward to the layer transition point 24. The logical addressing continues at the start 25 of the second section 23 and ends at the end 26 of the second section 23.

Consequently a third section 27 on the first layer 20 and a fourth section 28 on the second layer 21 are comprised in the physical addressing of the record carrier but not in the logical addressing. During mastering the layer transition point 24 is determined by processing the video data and searching for an appropriate scene, for instance with a low bit rate, occurring at a cell boundary where a non-seamless layer transition can be implemented. On a PTP record carrier there is no specific additional objective to balance the amount of video information on both layers 20, 21. Consequently the first section 22 and a second section 23 can have different sizes and the second section 23 can be smaller, equal or larger than the first section 22.

FIG. 3 shows video information duplicated on a dual layer OTP record carrier.

FIG. 3 shows what happens when no special measures are taken when copying a source multiplayer record carrier to a target multiplayer record carrier.

When a dual layer OTP record carrier as shown in FIG. 1 is duplicated in the regular fashion the video information is retrieved from logical address space of the source record carrier and provided to the recorder for recording on the target record carrier. A single stream or data file with video information is provided to the recorder and consequently the recorder must, just like during authoring, find a suitable point in the video information for the layer transition point. FIG. 3 shows the two laywers 30, 31 of the record carrier with a fixed layer transition point at the end 33 of the physical address space. The first layer 30 comprises a pre-embossed section 34 and a first section 32 comprising the first part of the video information. To help understanding the relationship between the video information on the source record carrier of FIG. 1 or 2 and the video information in FIG. 3 the location in the video information of the original layer transition point 6, 24 of the FIG. 1 and 2 is indicated in FIG. 3 by a line 35. The layer transition point 33 if fixed at the end of the logical and physical address space of the first layer 30 and marks the end of the first section 32 of video information. Because the layer transition point has moved towards the end oof the video information on the target record carrier, video information from both the first layer and second layer of the source record carrier is recorded on the first layer of the target record carrier. The video information and the logical address space continues on the second layer, from the start 36 of the second section 37 to the end 38 of the second section 37. The drawback of this method of copying is that the video information must be processed and that the original layer transition point of the source record carrier is lost and a new potentially disadvantageous layer transition point must be chosen for the target record carrier.

FIG. 4 shows video information duplicated on a dual layer PTP record carrier.

Just like the description of FIG. 3 FIG. 4 shows what happens when no special measures are taken when copying a source multiplayer record carrier to a target multiplayer record carrier.

When a dual layer PTP record carrier as shown in FIG. 2 is duplicated the video information is retrieved from logical address space of the source record carrier and provided to the recorder for recording on the target record carrier. A single stream or data file with video information is provided to the recorder and consequently the recorder must, just like during authoring, find a suitable point in the video information for the layer transition point. FIG. 4 shows a layer transition point 43 determined by the recorder close to the physical end of the first layer 40. The first layer 40 comprises a pre-embossed section 44 and a first section 42 comprising the first part of the video information. The layer transition point 43 marks the end of the first section 42 and the end of the logical address space of the first layer 30. The video information is recorded up to the layer transition point 43 and continues in the logical address space on the second layer, from the start 45 of the second section 46 to the end 47 of the second section 46. The recorder can not balance the amount on video information comprised in each section 42, 46 because the layer transition point 43 is fixed. The third section 48 is not comprised in the logical addressing. The drawback of this method of copying is that the video information must be processed and that the original layer transition point of the source record carrier is lost and a new potentially disadvantageous layer transition point must be chosen for the target record carrier.

FIG. 5a shows a file structure for transferring the video information from a playback device to a recorder.

In order to avoid the mandatory processing of the video information and to offer a handle to the recorder to replicate the original division of the video information over the two layers of the target record carrier identical to the division on the source record carrier FIG. 5a shows a file structure 50, 53 that comprises a first file 50 and a second file 53. The first file comprises the video information of the source multiplayer record carrier. Because the playback device only provides a single stream or file with a continues logical address space comprising both the first section 51 of the video information read from the first section on the first layer and the second section 52 of the video information read from the second section on the second layer of the source multiplayer record carrier, a second file 53 is provided by the recorder in addition to the first file 50. The second file 53 comprises the logical address of the layer transition point. This way the recorder does no longer need to process the video information but can use the provided logical address of the original layer transition point of the source record carrier to determine the appropriate layer transition point for the target record carrier.

A constant offset in the physical address space of the target record carrier compared to the source record carrier can be easily taken into account by the recorder. An advantage of a separate second file 53 is that this second file 53 can be transferred to the recorder independent of the first file 50 comprising the video information.

The playback must transfer the second file 53 either before the first file 50, if a separate file is used. In the DVD file structure a suitable file to comprise the logical address of the layer transition point is the IFO file which also contains other information pertinent to the video information in the VOB file or VOB files.

FIG. 5b shows a further file structure for transferring the video information from a playback device to a recorder.

Another possibility is to include the logical address of the layer transition information in a section 55 of the first section 56 of the file 54 comprising the first section of the video information. Shown is the situation where the section 55 comprising the logical address of the layer transition point is located at the beginning of the first section 56.

Because the recorder must know the position of the layer transition point before the recording of the video information starts the logical address of the layer transition point must be placed before the video information in order to ensure that the recorder receives the logical address of the layer transition point before the recording.

Now that the effects of the regular duplication process have been explained in FIGS. 1, 2, 3 and 4, FIG. 6 will show how transferring the position of the layer transition point to the recorder can be used to obtain an appropriate adjustment of the logical addresses on the target record carrier.

FIG. 6 shows a dual layer OTP record carrier prepared for duplicating another dual layer OTP record carrier.

The dual layer record carrier of FIG. 6 comprises a first layer 60 and a second layer 61. The first layer comprises a first section 68 which is the pre-embossed area comprising record carrier information for the recorder and also for the playback device. This area is non-recordable. A second section 62 is skipped by moving the first logical address 63 to a different physical address closer to the end of the first layer. Thus the logical address range on the first layer 60 is limited to the third section 64 which runs from the first logical address 63 to the last physical address of the first layer 61.

This third section is then subsequently used to record the first section 51 of video information of FIG. 5a. The first logical address is moved to that physical address that results in the first section 51 of video information of FIG. 5a fitting exactly in the third section 64 on the target record carrier.

The remaining second section 52 of the video information of the file 50 of FIG. 5a can be subsequently recorded in the fourth section 65 located on the second layer 61 of the target record carrier. The recorder reduces adjusts the physical address of the first logical address by performing offset calculations on the logical address of the layer transition point as included in and retrieved from files 53, 54 of FIG. 5a or FIG. 5b or as determined from the video information itself by the recorder.

It should be noted that instead of reading the logical address of the transition point on the source record carrier from the second file 53 of FIG. 5a, an appropriate layer transition point can also be derived from the video information itself by processing the video information and searching for a position in the video information where certain conditions are met, in particular where a non-seamless transition can be used, where a cell boundary is located and positions where the video information contains a scene meeting certain criteria regarding bit rate and content of the scene. A low bit rate and a dark scene or a scene without action or fast moving contents are examples of positions of the video information suitable for a layer transition point.

Thus, when the recorder starts recording the video information for instance from the first file 50 of FIG. 5a the layer transition is automatically forced because the recorder starts recording at the first logical address and reaches the last physical address of the first layer 60, corresponding to the end of the third section 64 exactly when the recording of the video information has progressed to that point in the video information where the layer transition point was located on the source record carrier. The recorder already includes all necessary means to allow the recorder to perform an automatic layer transition when the last physical address of the first layer is reached. By adjusting the physical address of the first logical address on the first layer the means in the recorder to perform an automatic layer transition will be triggered by the reaching of the maximum logical address during the recording and will perform a layer transition automatically. When the first logical address on the first layer was left at the start of the default physical address on the first layer the automatic layer transition would be performed at a potentially inappropriate position in the video information. It is the adjustment of the physical address of the first logical address on the first layer that ensures that the layer transition on the target record carrier is located at the same appropriate position on in the video information on the target record carrier as was chosen carefully during the authoring of the record carrier.

When reaching the maximum physical address of the first layer 60 the recorder automatically performs a layer transition and continues recording the remaining video information from the start of the second section 52 of the first file 50 of FIG. 5a in the fourth section 65 on the second layer 61. The recording is completed at the end 66 of the fourth section 65. No recording in the fifth section 67 will need to be performed except for instance de-icing for readability requirements. The physical address of the first logical address 63 on the first layer 60 is recorded on the record carrier in an index file, for instance in the case of a DVD structured record carrier in the VTSM file.

FIG. 7 shows a dual layer PTP record carrier prepared for duplicating another dual layer PTP record carrier.

The dual layer record carrier of FIG. 7 comprises a first layer 70 and a second layer 71. The first layer 70 comprises a first section 70a which is the pre-embossed area comprising record carrier information for the recorder and also for the playback device. This area is non-recordable. A second section 72 is skipped by moving the first logical address 73 to a different physical address closer to the end of the first layer. Thus the logical address range on the first layer 70 is limited to the third section 74. To record the first section 51 of video information of FIG. 5a, the recorder has arranged for a relocation of the first logical address 73 located such that the first section 51 of video information of the file 50 of FIG. 5a fits exactly in the third section 74 of the first layer 70 the target record carrier. The remaining second section 52 of the video information of the file 50 of FIG. 5a can be subsequently recorded in the fourth section 76 on the second layer 71 of the target record carrier. To achieve this the recorder reduces the logical addressing space of the first layer 70 by moving the physical address of the start of the logical address space towards the end of the physical address space to provide an exact fitting storage area for the first section 51 of video information of FIG. 5a. Thus the end of the first section 51 of video information when recorded in the third section 74 will coincide with the last physical address of the first layer 70 and thus with the layer transition point of the target record carrier.

It should be noted that an appropriate layer transition point, on which the shift of the first logical address is based, can also be derived from the video information itself by processing the video information and searching for a position in the video information where certain conditions are met, in particular where a non-seamless transition can be used, where a cell boundary is located and positions where the video information contains a scene meeting certain criteria regarding bit rate and content of the scene. A low bit rate and a dark scene or a scene without action or fast moving contents are examples of positions of the video information suitable for a layer transition point.

Although the explanation of FIG. 6 and 7 uses the file structure of FIG. 5a, the file structure of FIG. 5b can be used equally well.

Thus, when the recorder starts recording the video information from the first file 50 of FIG. 5a the layer transition is automatically forced because the recorder reaches the last physical address, the end of the physical address space, of the first layer 70, exactly when the recording of the video information has progressed to that point in the video information where the layer transition point was located on the source record carrier. When reaching the last physical address of the first layer 70 the recorder automatically performs a layer transition and continues recording the remaining video information from the second section 52 of the first file 50 of FIG. 5a from the start 75 of the fourth section 76 on the second layer 71 up until the end of the fourth section 76. No recording in the fifth section 78 will need to be performed except for for instance de-icing as may be required for instance playability requirements. Because on an PTP type record carrier the recorder commences outward from the start 75 of the fourth section 76 after the layer transition the sixth section 78 remains accessible to the recorder. The end 77 of the fourth section 76 is determined by the end of the video information.

FIG. 8 shows a system for duplicating dual layer record carriers, comprising a playback device and a recorder.

A source dual layer record carrier 80 is to be duplicated on the target dual layer record carrier 81. A playback device 82 can access the information on the source record carrier through a basic engine 84 which performs the readout and decoding of the information read from the record carrier 80. The processor 88 is coupled to the basic engine 84 and can both issue instructions to the basic engine 84 and receive the information retrieved by the basic engine 84.Using the basic engine 84 the processor 88 can retrieve both the video information and the logical address of the layer transition point from the source record carrier 80 by first retrieving the video information from the first layer of the source record carrier 80, noting the logical address of the layer transition point, and subsequently retrieving the remaining video information from the second layer of the source record carrier 80.

The processor 88 is further coupled to a user interface 86 and to an output 90. Through the user interface 86 the user can instruct the playback device to start a duplication process, initiated by the playback device or can adjust the format of the files or data stream provided by the playback device 82 to the recorder 83. For instance a selection between the two file formats illustrated in FIG. 5a and FIG. 5b respectively can be achieved to ensure compatibility if different recorders require different file formats. The user can also instruct the playback device to suppress the output of the logical address of the layer transition point to the recorder or to a file.

The file, files, or data stream comprising the video information and the logical address of the layer transition point are provided by the processor 88 via the interface 90 to the input 91 of the recorder 83. When the recorder 83 receives the file, files, or data stream comprising both the video information and the logical address of the layer transition point the input 91 provides the file, files or data stream to the processor 89.

The processor 89 is coupled to a user interface 87. Through the user interface 87 the user can instruct the recorder to start a duplication process, or instruct the recorder to initiate the transfer of the files from the playback device 82 to the recorder 83. In addition the user interface 87 can be used to adjust the format of the files or data stream accepted by the recorder 83 from the playback device 82. For instance a selection between the two file formats illustrated in FIG. 5a and FIG. 5b respectively can be achieved to ensure compatibility if different playback devices provide different file formats. The user interface 87 can also be used to instruct the recorder 83 to ignore the logical address of the layer transition point as provided by the playback device and instead process the video information to locate an appropriate position for the layer transition point

For the duplicating process the playback device 82 performs the following steps:

retrieving video information from a first layer on the source multi layer record carrier using the basic engine 84 under control of the processor 88 where the optical pickup is focused on the first layer.

retrieving video information from a second layer on the source multi layer record carrier using the basic engine 84 under control of the processor 88 where the optical pickup is in this case focused on the second layer.

transferring all video information retrieved from the first layer and the second layer to a recording device.

The transfer can be initiated by the user through the user interface 86 of the playback device 82 or through the user interface 87 of the recorder 83. Alternatively the transfer can be initiated through the interfaces 90, 91 of the playback device 82 and/or recorder 83 in case the playback device 82 and/or the recorder 83 are computer controlled through their interfaces, for instance in the case of IDE-interface controlled playback devices and recorders used in Personal Computers.

determining a logical address of the layer transition position

The recorder then must determine a suitable point in the video information so that this suitable point can be lined up with the fixed layer transition point of the target record carrier.

This can be achieved by obtaining the logical address of the layer transition point on the source record carrier from the playback device, for instance by retrieving this logical address from a file provided by the playback device, or by processing the video information and determining the logical address of an appropriate position for a layer transition.

determining a size of a first section of the video information

By determining the size of the first section of the video information up to the layer transition point of the source record carrier the correct size of the logical address space on the first layer of the target record carrier can be established.

adjusting a physical location of a first logical address on a first layer of the target multi layer record carrier so that when starting a recording of the first video section from the adjusted first logical address the determined layer transition point coincides with a logical address of a layer transition point of the target record carrier

By subtracting the size of the first section of the video information from the last, in a normal addressing system the largest, physical address the correct physical address for the first logical address can be obtained. The resulting logical address space is exactly large enough to fit the first section of video information.

recording the video information transferred to the recording device on the target multi layer record carrier starting at the adjusted first logical address on the first layer of the target multi layer record carrier.

After adjusting the logical address space the processor 89 of the recorder 83 can start the recording the video information.

The recorder 83 records the received video information on the target multi layer record carrier 81 by processing the video information using the processor 89. The processor 89 subsequently provides the video information in an appropriate form, as defined by the recording standard, together with other required information such as addressing information to the basic engine 85 where the information is converted into a signal suitable for recording on the target multi layer record carrier 81.

The layer transition is performed automatically by the recorder 83 when the recorder 83 reaches the end of the physical address space.

When the logical address of the layer transition point is not determined by processing the video information the playback device needs to perform the following additional two steps:

retrieving a layer transition point from the source multi layer record carrier, using the basic engine 84 under control of the processor 88. The logical address of the layer transition point can be determined in several ways. The playback can retrieve the logical address of the layer transition position from an entry in the lead-in of the record carrier or can determine the position of the layer jump by noting the logical address of the layer transition point while retrieving the video information from the source record carrier. For duplication all video information must be retrieved from the record carrier and the playback will thus, in the case of a dual layer source record carrier, automatically encounter the layer transition.

transferring the layer transition point to the recording device

The transfer of the logical address of the layer transition point can be initiated by the user through the user interface 86 of the playback device 82 or through the user interface 87 of the recorder 83. Alternatively the transfer can be initiated through the interfaces 90, 91 of the playback device 82 and/or recorder 83 in case the playback device 82 and/or the recorder 83 are computer controlled through their interfaces, for instance in the case of IDE-interface controlled playback devices and recorders used in Personal Computers. It is obvious that the transfer of the logical address of the layer transition point can be transferred separate or together with the transfer of the video information.

When the logical address of the layer transition point is determined by processing the video information the playback device needs to perform the following additional step instead of the two additional steps outlined above:

processing the video information to determine a logical address for a layer transition point complying with requirements for a layer transition.

1. Recording device for recording information provided to an input on a multi layer record carrier with a first layer, a second layer and a layer transition point, the recording device comprising writing means for writing information on the first layer and the second layer of the multi layer record carrier and a processing means coupled to the input and to the writing means,
characterized in that the processing means comprises layer transition point determining means and logical address adjusting means where the logical address adjusting means is operative to adjust a first logical address based on a layer transition point provided by the layer transition point determining means.

2. Recording device as claimed in claim 1,
characterized in that the layer transition point determining means is arranged to determine the layer transition point by processing the video information.

3. Recording device as claimed in claim 1,
characterized in that the layer transition point determining means is arranged to determine the layer transition point from an information file provided to the recording device.

4. Method for duplicating a source multi layer record carrier on a target multi layer record carrier the comprising the steps of
retrieving video information from a first layer on the source multi layer record carrier
retrieving video information from a second layer on the source multi layer record carrier
transferring the video information retrieved from the first layer and the second layer to a recording device
determining a suitable layer transition point in the video information
dividing the video information into a first video section and a second video section
adjusting a physical location of a first logical address on a first layer of the target multi layer record carrier so that when starting a recording of the first video section from the adjusted first logical address the determined layer transition point coincides with a logical address of a layer transition point of the target record carrier
recording the video information transferred to the recording device on the target multi layer record carrier starting at the adjusted first logical address on the first layer of the target multi layer record carrier.

5. Method for duplicating a source multi layer record carrier as claimed in claim 4 characterized in that the step of determining a suitable layer transition point comprises the step of:
processing the transferred video information to determine a layer transition point complying with requirements for a layer transition

6. Method for duplicating a source multi layer record carrier as claimed in claim 4, characterized in that the step of determining a suitable layer transition point comprises the steps of
retrieving a layer transition point from the source multi layer record carrier
transferring the layer transition point to a recorder

7. Method for duplicating a source multi layer record carrier as claimed in claim 4, 5 or 6, characterized in that the step of adjusting a first logical address on a first layer of the target multi layer record carrier so that the determined layer transition point coincides with a logical address of a layer transition point of the target record carrier comprises the steps of:
calculating a logical address offset of the layer transition point from a start of the video information
subtracting the logical address offset from a maximum logical address of the first layer of the target record carrier to obtain an adjusted first logical address
storing the adjusted first logical address in an index file on the target record carrier

8. Method for duplicating a source multi layer record carrier as claimed in claim 4, 5, 6 or 7, characterized in that the method further includes a step of recording dummy information in areas unrecorded after completion of the recording of the video information.
